(19) United States
(12) Patent Application Publication
(10) Pub. No.: US 2023/0401912 A1
(43) Pub. Date: Dec. 14, 2023

(54) Electronic Security Device

(71) Applicant: Security Seal Technology Limited, London (GB)

(72) Inventor: John Brogan, London (GB)

(21) Appl. No.: 18/102,461

(22) Filed: Jan. 27, 2023

(30) Foreign Application Priority Data
Jun. 13, 2022 (GB) GB2208618.5

(51) Int. Cl. G07C 9/00

(52) U.S. Cl. CPC G07C 9/00182

(57) ABSTRACT

A flight cart electronic security device for monitoring access to a flight cart, the electronic security device comprising; a first portion, a second portion, and a retaining mechanism, the retaining mechanism configured to retain the first portion relative to the second portion, wherein the electronic security device further comprises a control unit, wherein the control unit is configured to receive information from a sensor concerning the status of the first portion relative to the retaining mechanism, and further wherein the control unit is configured to control the status of the electronic security device in response to the information from the sensor and to an authorization signal. There is further described a kit of parts comprising a flight cart electronic security and an authorization device configured to emit an authorization signal. There is further described use of a flight cart electronic security device.

### CROSS-REFERENCE TO RELATED APPLICATIONS

This application claims priority to United Kingdom Patent Application Number GB2208618.5, filed on Jun. 13, 2022, the content of which is incorporated herein by reference.

### STATEMENT REGARDING FEDERALLY SPONSORED RESEARCH OR DEVELOPMENT

Not Applicable.

### FIELD OF INVENTION

The present invention relates to a flight cart electronic security device for monitoring access to a flight cart, a kit of parts comprising a flight cart electronic security device and an authorization device, and to use of a flight cart electronic security device.

### BACKGROUND

Secure vessels often carry valuable cargo, and unauthorized access to such cargo may risk the safety of the contents leading to unwanted losses. As such, it is beneficial to restrict access to secure vessels to prevent the negative consequences often associated with unauthorized access.

Catering and retail flight carts are an example of a secure vessel used to transport goods around the world. Catering and retail flight carts are often susceptible to unauthorized access, as their continual movement in the responsibility of various and ever changing parties renders controlling the access to the carts very challenging.

It is known in the art to use inexpensive plastic seals and padlocks to prevent access to secure vessels and deter tampering. However, there is benefit in reducing reliance on single use devices, especially single use plastics, due to their resource demand and negative environmental impact. Further, inexpensive plastic seals and padlocks are prone to tampering and breakage.

Objects and aspects of the present claimed invention seek to alleviate at least these problems with the prior art.

### BRIEF SUMMARY OF THE INVENTION

According to a first aspect of the invention, there is provided a flight cart electronic security device for monitoring access to a flight cart, the electronic security device comprising; a first portion, a second portion, and a retaining mechanism, the retaining mechanism configured to retain the first portion relative to the second portion, wherein the electronic security device further comprises a control unit, wherein the control unit is configured to receive information from a sensor concerning the status of the retaining mechanism, and further wherein the control unit is configured to control the status of the electronic security device in response to the information from the sensor and to an authorization signal.

In this way, a device for improved monitoring and detection of illicit circumvention of a pre-defined operational procedure is provided. The device performs the function of an electronic seal. The authorization signal permits authorized access to the flight cart and deters tampering from both unauthorized and authorized users. Advantageously, the device can be fitted to an external portion of a flight cart. As such, a device that is compatible with and can be retrofitted to a wide range of flight carts is provided.

Preferably, the control unit is further configured to store data concerning the status of the electronic security device comprising at least one of a sealing status or a tamper status. In this way, data regarding the possibility of tampering or incorrect seal use is stored by the control unit. Preferably, the control unit is further configured to store data concerning the authorization signal. In this way, data regarding the authorization device emitting the authorization signal is stored by the control unit. Therefore, a user may download the data stored by the control unit to review of the historic data of the electronic security device.

Preferably, the control unit is configured to issue a unique vessel identification (ID) to the flight cart. Preferably, the data concerning the authorization signal comprises at least one of a current sealing identification (ID), a previous sealing ID or a future sealing ID. In this way, the control unit stores both present, historic and predicted future data regarding the electronic seal. Preferably, the sealing IDs are randomly generated.

Preferably, the electronic security device further comprises a data transmitter configured to transmit data from the control unit. Preferably, the flight cart electronic security device is configured to transmit data to an external storage unit. More preferably, the flight cart electronic security device is configured to wirelessly transmit data to an external storage unit. In some embodiments, the external storage unit comprises cloud storage. In this way, historic data collected by the control unit can be stored for future access.

In some embodiments, the control unit is configured to store data regarding the flight cart electronic security device to a portable external device. For example, the portable external device may be a personal handheld device such as a mobile phone or tablet. In this way, data regarding the status of the electronic security device and/or the authorization device and/or signal can be easily accessed by the user.

Preferably, the electronic security device comprises a digital display. Preferably, the digital display is an LED display. Preferably, the digital display is configured to display one or more of a current sealing identification (ID), a previous sealing ID, a future sealing ID, a sealing status or a tamper status.

Preferably, the electronic security device further comprises an audible alarm. Preferably, the electronic security device further comprises a visual alarm. More preferably, the electronic security device comprises an audible alarm and a visual alarm. In this way, the electronic security device can alert the user that the sealing status and/or tamper status require attention prior to normal use. For example, the user may check the contents of the flight cart for tampering or theft if the tamper status indicates that tampering may have occurred.

Preferably, the control unit is configured to receive radio frequency identification technology (RFID) authorization from an authorization device. In this way, improved ease of authorizing access is provided. Alternatively, the control unit is configured to receive Bluetooth authorization from an authorization device. It is understood that the authorization device may be a Bluetooth enabled device, such as a mobile phone or portable tablet.

Preferably, the electronic security device comprises a power source. In some embodiments, the power source is rechargeable. Advantageously, the device does not require wired communication to a power source and can be used on flight carts in remote locations or flight carts that are frequently moved. Preferably, the electronic security device comprises a power save mode configured to conserve power.

Preferably, the electronic security device further comprises a securing mechanism configured to retain the first portion relative to the second portion to prevent access to the flight cart. In this way, the first portion can be locked in position relative to the second portion. Unlike the retaining mechanism, the securing mechanism prevents access to the flight cart. A function of the retaining mechanism is to act as a visual deterrent. It is understood that the security device may comprise a lock external to the device. Preferably, the securing mechanism comprises a motorized latch.

Preferably, the electronic security device comprises a battery. Preferably, the battery comprises a lithium phosphate and/or a lithium polymer.

According to a second aspect of the present invention there is provided a kit of parts comprising; the flight cart electronic security device of the first aspect of the present invention; and an authorization device configured to emit an authorization signal.

Preferably, the authorization device is a radio frequency identification technology (RFID) device. Preferably, the authorization device is an encrypted RFID device. In this way, individual users can be identified from their authorization device and improved monitoring of access to the flight cart is provided. In some embodiments, the authorization device is a Bluetooth device. For example, the authorization device may be a Bluetooth enabled device, such as a mobile phone or portable tablet. In this way, the user is not required to be next to the electronic security device to provide an authorization signal and may instead be located at an opposite side of the room or aircraft. In some embodiments, the authorization device is retrofitted to an existing user device. For example, an existing employee ID or access authorization card.

According to a third aspect of the present invention there is provided use of the flight cart electronic security device of the first aspect of the present invention to monitor access to a flight cart.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 depicts an electronic security device in accordance with the first aspect of the present invention, the electronic security device shown retrofitted to a flight cart;

FIG. 2 depicts a second embodiment of the electronic security device of FIG. 1 fitted to a flight cart;

FIGS. 3A to 3B depict a third embodiment of the electronic security device of FIG. 1; and

FIG. 4 depicts a flow diagram setting out the steps of an illustrative method of operating the electronic security device of the invention.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

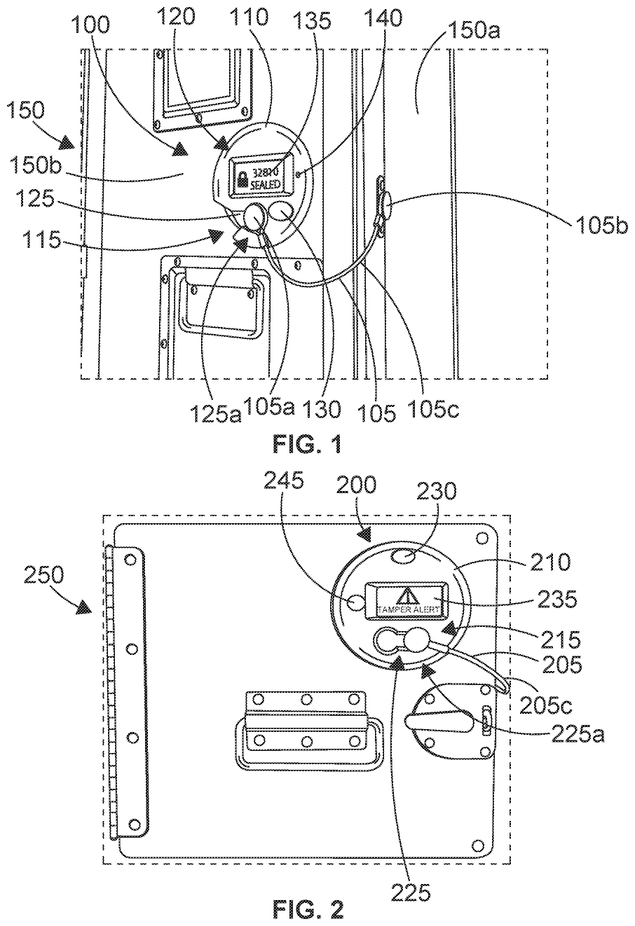

According to various example embodiments of the present general inventive concept, an electronic security device is provided. With reference to FIG. 1, there is illustrated an electronic security device 100 for monitoring access to a flight cart. The device 100 is shown retrofitted to an existing flight cart 150. The device 100 comprises a first portion 105, a second portion 110 and a retaining mechanism 115 configured to retain the first portion 105 relative to the second portion 110.

The first portion 105 comprises a first end 105a configured to be removably retained in the second portion 110. The second portion 110 comprises a slot 125 configured to house a portion of the first end 105a of the first portion 105 in a retained position (illustrated in FIG. 1) at a retaining end 125a of the slot 125. The retaining mechanism 115 is located adjacent the slot 125 and is configured to retain the first portion 105 in the retained position. The retaining mechanism 115 further comprises a sensor to detect when the first member 105 is in the retained position. The sensor comprises a magnetic circuit between the first portion 105 and the retaining end 125a of the slot 125, wherein the circuit is broken when the first portion 105 is removed from the retaining end 125a. In this embodiment, the device 100 is affixed to the flight cart 150 such that the slot 125 is a horizontal slot and the first portion 105 has a reduced likelihood of accidental removal from the slot 125, such as due to gravity.

The first portion 105 comprises a second end 105b fixed to a first area 150a of the flight cart 150. The second portion 110 is fixed to a second area 150b of the flight cart 150. In this embodiment, the second area 150b is the door of the flight cart 150 and the first area 150a is an adjacent side of the body of the flight cart 150. In this way, when the first portion 105 is in the retained position, the user is unable to access the flight cart 150 contents due to the restriction on the opening of the flight cart 150 door. The device 100 is affixed to the flight cart 150 such that the first area 150a is located proximate the retaining end 125a of the slot 125. As such, when a user attempts to open the door of the flight cart 150, the first portion 105 remains in the retained position. The sensor is configured to detect when a user attempts to open the door of the flight cart 150 while the first portion 105 remains in the retained position.

The first portion 105 comprises a flexible elongate member 105c connecting the first end 105a to the second end 105b. The elongate member 105c comprises a long-wearing and tamper deterring material, such as steel. The elongate member 105c is pivotably attached to the second end 105b so that the first portion 105 does not inhibit loading and unloading of the flight cart 150.

The second end 105b is fixed to the first area 150a such that the first end 105a can be inserted into the slot 125 only when the first member 105 is fully extended. In this way, the distance that the door of the flight cart 150 can be opened is minimized.

The device 100 further comprises a control unit 120 located within the second portion 110. The control unit comprises an authorization receiver 130 located adjacent the slot 125. The authorization receiver 130 is configured to receive an authorization signal from an external authorization device, such as a radio frequency identification technology (RFID) device. The authorization receiver 130 is configured to receive a signal from an authorization device placed, at most, 1 cm from the authorization receiver 130. The authorization receiver 130 is marked to aid user identification of the location where their authorization device should be used.

The control unit 120 further comprises an authentication unit configured to authenticate the authorization signal received by the authorization receiver 130. If the user is not authorized to perform the requested action, the authentication unit will detect that the action is not approved and the control unit 120 will not action the request. If the authentication unit detects that the action is approved, the control unit 120 will action the request.

When the user wishes to seal the contents of the flight cart 150, the user can place the first portion 105 in the retained position within the slot 125 of the second portion 110. The user can place their RFID authorization device proximate the authorization receiver 130 to seal the device 100. If the user is authorized to seal the device 100, the authentication unit identify that the request is allowed and the control unit 120 will instruct authorize the sealing request.

When a user is authorized to access the contents of the flight cart 150, the user can place their RFID authorization device proximate the authorization receiver 130 to disengage the seal on the device 100. The user can remove the first portion 105 from the slot 125 without fear of triggering a ‘tamper alert’ status. The user can then freely access the contents of the flight cart 150.

The control unit 120 is configured to receive information concerning the status of the retaining mechanism 115. In particular, the control unit 120 is configured to receive data regarding whether the retaining mechanism 115 is retained and sealed and thereby has a “sealed′ status, or not sealed and thereby has a ‘not sealed’ status. The ‘not sealed’ status may be obtained whether the first portion 105 is in the retained position or not in the retained position. Further, the control unit 120 is configured to receive data regarding whether the retaining mechanism 115 may have been tampered with and thereby has a ‘tamper alert’ status. If tampering is unlikely to have occurred, the retaining mechanism 115 has an ‘untampered’ status.

Examples of events that may cause the retaining mechanism 115 to obtain a ‘tamper alert’ status are; a user failing to authorize sealing of the electronic security device 100 after a predetermined period of time, thereby leaving the flight cart 150 unsecured and open to tampering; a user attempting to open the door of the flight cart 150 while the first portion 105 remains in the retained position; and removal of the first portion 105 from the retained position without prior authorization from an authenticated authorization signal received by the authorization receiver 130.

The control unit 120 is further configured to control the status of the retaining mechanism 115 in response to an authorization signal from an external authorization device. For example, if the user is authorized to access the contents of a sealed flight cart 150, in response to an authorization signal from this user, the control unit 120 instructs the retaining mechanism 115 to obtain the ‘not sealed’ status.

The control unit 120 is further configured to store data regarding the sealing status and tamper status of the retaining mechanism 115 and data concerning the authorization signal, such as data regarding the user/s assigned to the authorization device sending the authorization signal and metadata, including the location and time when the authorization signal was sent. The data concerning the authorization signal further comprises a current sealing identification (ID), a previous sealing ID and a future sealing ID. If the authorization signal is the first signal sealing the device 100, then no previous sealing ID is provided.

The device 100 further comprises a data transmitter located within the second portion 110 and configured to wirelessly transmit data from the control unit 120. For example, the data can be transmitted to a user's tablet or computer to allow the user to review the data from an external location to the device 100.

The device 100 comprises an LED display 135 located on the second portion 110 and configured to display the applicable sealing status, tamper status, and sealing IDs. One or more status or ID may be shown on the display 135 for ease of identification of the status of the device 100. Illustrated in FIG. 1 is the display 135 displaying the present sealing ID and the sealing status. Additional visual aids, such as an image of a padlock or a warning sign, may be displayed to ease user identification of the status of the device 100.

The device 100 further comprises a visual alarm comprising a light 140 which may flash, change color and/or turn on and/or off in response to a change in status or sealing ID or in response to incorrect protocol followed by the user. The device 100 further comprises an audible alarm configured to engage in response to a change in status or sealing ID and/or in response to incorrect protocol followed by the user. The visual and audible alarm assist identification of the status of the device 100 and prompt action by the user if tampering or incorrect device 100 use has occurred. Further, if a ‘tamper alert’ status is obtained, the audible alarm is configured to sound, deterring the offender from continuing their act for risk of getting caught. The device 100 is also configured to transmit a notification to a remote device, such as a supervisor or manager's computer or tablet, notifying the remote user that a ‘tamper alert’ status has been obtained. The remote user can then action the closest staff member to respond to the alert.

The device 100 further comprises a power source comprising a battery located within the second portion 110. The battery life of the battery is at least two years.

There is no lock preventing the first portion 105 from being removed by the user while the device 100 has a ‘sealed’ status. However, should the first portion 105 be removed from the retained position without prior authentication of an approved authorization signal received by the authorization receiver 130, the audible alarm is engaged. The alarm prompts the unauthorized user that the device 100 is sealed and requires an authorized authorization device to unseal the device 100 before opening the door of the flight cart 150. The ‘tamper alert’ status will be displayed on the display 135 if the sensor detects that the first portion 105 is removed from the retained position with the device has a ‘sealed’ status.

Attempting to use an authorization signal from an unauthorized device to seal or unseal the device 100 will not prompt a ‘tamper alert’ status to be obtained. Instead, the authorization signal will not device 100 will not be authorized and the action desired by the user of the unauthorized device will not be actioned.

In embodiments where the device 100 further comprises a securing mechanism, the authentication unit will identify that the request is allowed and the control 120 unit will instruct the securing mechanism to engage and thereby secure the first portion 105 in a secured position. In the secured position, the user is prevented from removing the first portion 105 from the secured position and the flight cart 150 is electronically locked and sealed. The location of the first portion 105 in the retained and secured positions is the same, however, the retaining mechanism is not engaged when the first portion 105 is in the retained position. If the sensor detects that the first portion 105 is not in the retained position when sealing is authorized, the sealing mechanism is not engaged and an alert is issued to the user. When a user is authorized to access the contents of the flight cart 150, the user can place their RFID authorization device proximate the authorization receiver 130 to disengage the seal on the device. The control unit 120 instructs the securing mechanism to disengage, wherein the first portion 105 is thereby in the retained, but not secured, position and the user can remove the first portion 105 from the slot 125. The user can then freely access the contents of the flight cart 150.

In a similar manner, a Bluetooth authorization device may be located proximate the authorization receiver 130 in other embodiments of the invention. Bluetooth authorization permits the user to be located further from the authorization receiver 130 when authorizing disengagement of the seal than when they are using some types of RFID authorization device, such as short-range RFID cards which operate only when they are within centimeters of the authorization receiver 130. Namely, the user may be in the same room or aircraft as the flight cart 150 (i.e. up to meters away) but is not required to place the authorization device on or very near to (i.e. within centimeters of) the authorization received 130.

With reference to FIG. 2, a second embodiment of the device 200 fixed to a secure vessel 250, namely a flight cart, is illustrated. In the following description similar numerals will be used for similar parts of the embodiment. The device 200 comprises a first portion 205, second portion 210 and a retaining mechanism 215 configured to retain the first portion 205 relative to the second portion 210. In this embodiment, an authorization receiver 230 is located distal from the retaining mechanism 215 such that a digital display 235 is located between the retaining mechanism 215 and the authorization receiver 230. Illustrated in FIG. 2 is the display 235 displaying the tamper status, namely that the retaining mechanism 215 has a ‘tamper alert’ status. The retaining end 225a of the slot 225 is illustrated.

The first portion 205 comprises an elongate member 205c coated in plastic to reduce the likelihood of damage the flight cart 250 and injury to the user. The device 200 further comprises a power source comprising a battery located within the second portion 210. A standby button 245 is located adjacent the display 235 and configured to allow the user to place the device in a power conserving mode when the device 200 is not in use. The device 200 automatically enters a power conserving mode after a predetermined period of time after no authorization signal has been received. Therefore, the charge of the power source can be conserved and a more efficient device 200 is provided.

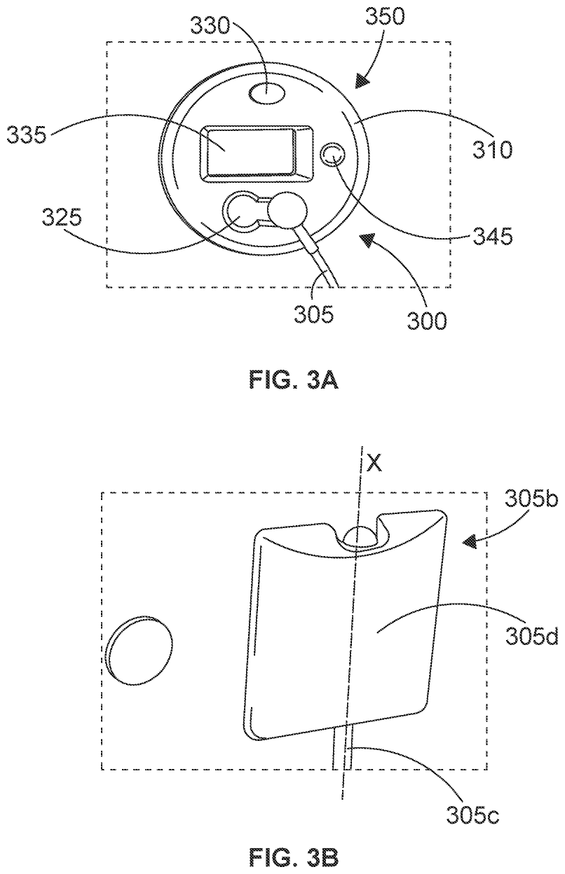

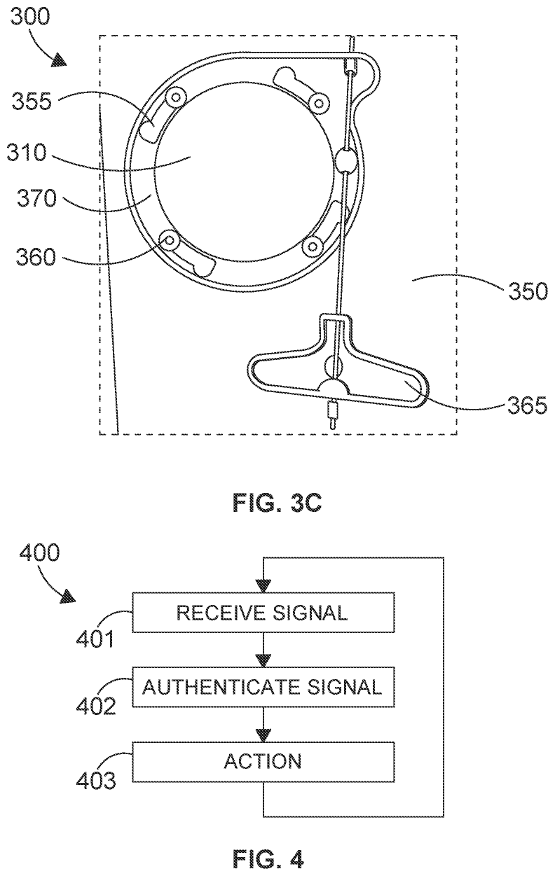

With reference to FIGS. 3A to 3C, a third embodiment of the device 300 fixed to a secure vessel 350, namely a flight cart, is illustrated. In the following description similar numerals will be used for similar parts of the embodiment. The device 300 comprises a first portion 305, second portion 310, slot 325, authorization receiver 330, display 335 and standby button 345 similar to those of the first two embodiments. In this embodiment, a second end 305b of the first portion 305 comprises a housing 305d configured to house an elongate member 305c, as illustrated in FIG. 3B. The housing 305d allows the elongate member 305c to rotate along a first axis X relative to the housing 205d. The housing 305d is securely fastened to the flight cart 350 to increase the difficulty of removal of the second end 305b from the vessel 350.

As illustrated in FIG. 3C, the rear of the device 300 is shown. The device 300 comprises a metal mounting ring 370 mounted to the second portion 310. The mounting ring 370 comprises four removal slots 355 equally spaced about the perimeter of the mounting ring 370. The device 300 is affixed to the flight cart 350 via four bolts 360 located through the second portion 310 and configured to be housed within the removal slots 355 of the mounting ring 370. The removable slots 355 have a variable aperture and permit the mounting ring 370 to be removed from the vessel 250 when the mounting ring 370 is in a removable position. When the mounting ring 370 is rotated to a secure position, shown in FIG. 3C, the aperture of the removal slots 255 does not permit the mounting ring 370 to pass over the bolts 360, and the mounting ring 370 is fixed to the second portion 310. When required, such as in an emergency, a handle 365 can be pulled to rotate the mounting ring 370 to the removable position relative to the second portion 310, and the mounting ring 370 can be removed from the second portion.

Access to the internal components of the second portion 310 is restricted when the mounting ring 370 is mounted to the second portion 310. As such, removal of the mounting ring 370 allows user access to the internal components of the second portion 310, such as for maintenance or battery replacement.

FIG. 4 illustrates a flow diagram setting out the steps of an illustrative method 400 of operating the electronic security device of the invention. The method 400 is iterative and may be performed multiple times.

The method 400 comprises a RECEIVE SIGNAL step 401, wherein a signal is received from a user's authentication device by the authorization receiver. For example, before a flight cart is loaded onto an aircraft, the user can place the first portion in the retained position and authorize sealing of the electronic security device affixed to the flight cart by placing their RFID authentication card near the authorization receiver. The authorization receiver comprises a light unit configured to flash red when the authorization receiver is preparing for use or authorization is not granted, and configured to flash green when authorization is granted.

There follows an AUTHENTICATE SIGNAL step 402 wherein the authentication unit authenticates the authorization signal received by the authorization receiver. In response to the AUTHENTICATE SIGNAL step 402, there follows an ACTION step 403 wherein the electronic security device performs at least one action depending on the outcome of the authentication by the authentication unit.

For example, if the user is authorized to seal the flight cart, the actions performed are as follows. The LED display displays the present sealing ID and the device indicates that the sealing mechanism is engaged, such as via the audible alarm or the LED display. The user may record the sealing ID for reference. The ‘sealed’ status is stored by the control unit. In embodiments where the electronic security device comprises a securing mechanism, the following action also occurs; the control unit instructs the securing mechanism to engage such that the first portion is in a secured position and access to the flight cart contents is restricted.

When the contents of the flight cart are no longer required, the user may then re-seal the flight cart in the manner outlined above.

When the contents of the flight cart are subsequently required during the flight, a user can authorize removal of the seal of the electronic security device by placing their RFID authentication card near the authorization receiver during a RECEIVE SIGNAL step 401. If the authorization is approved in the AUTHENTICATE SIGNAL step 402, the action taken in the ACTION step 403 is as follows. The LED display displays the previous sealing ID for the user to manually check. Data regarding the authorization signal is stored in the control unit including user data associated with the authorization signal and the date and time the signal was received. The ‘unsealed’ status is also stored. The door to the flight cart can now be opened and closed freely during use. In embodiments where the electronic security device comprises a securing mechanism, the following action also occurs; the control unit instructs the securing mechanism to disengage such that the first portion is in the retained position and can be removed from the slot, thereby allowing access to the contents of the flight cart.

If an unauthorized user attempts to remove the seal by placing their RFID authentication card near the authorization receiver during a RECEIVE SIGNAL step 401, the authorization does not approve the action in the AUTHENTICATE SIGNAL step 402. The action taken in the ACTION step 403 is as follows. The LED display displays a notification that the action is not approved or issue a ‘tamper alert’ status. Data regarding the authorization signal is stored in the control unit including user data associated with the authorization signal and the date and time the signal was received. The ‘tamper alert’ status is also stored. When the electronic security device comprises a securing mechanism, the following action also occurs; the control unit does not instruct the securing mechanism to disengage.

The above action occurs in a similar manner if the sensor detects a user has attempted to open the door of the flight cart 150 while the first portion 105 remains in the retained position.

However, if the authorization signal is authorized but the sensor in the retaining mechanism detects that the first portion is not removed from the slot after a predetermined period of time, the actions performed in the ACTION step 403 are as follows. The audible alarm sounds to inform the user that the device is unsealed and the flight cart is vulnerable to undesirable access from third parties. The authentication unit will not authorize an authorization signal in the consequent RECEIVE SIGNAL step 401 unless the authentication signal is received from an approved user, such as a manager or supervisor. In this way, the manager or supervisor can check the contents of the flight trolley for tampering or theft. The control unit stores the action as a ‘False Entry’.

When the approved user sends an authorization signal in the consequent RECEIVE SIGNAL step 401, the signal is authenticated in the AUTHENTICATE SIGNAL step 402 and the actions performed in the ACTION step 403 are as follows. The LED display displays the previous sealing ID and the future sealing ID for the user to check. Data regarding the authorization signal is stored in the control unit including user data associated with the authorization signal and the date and time the signal was sent. The ‘reset’ status is also stored. A similar ‘reset’ by an approved user is required when a ‘tamper alert’ status is obtained by the retaining mechanism, such as if someone has removed the first portion from the retained position without prior sending of an approved authorization signal.

During ground storage of the flight cart, it is envisaged that data can be transmitted from the electronic security device to a remote computer or tablet, or to a remote storage device. In this embodiment, the RECEIVE SIGNAL step 401 comprises receiving an authorization signal to begin wireless data transfer to the remote device. If the signal is approved in the AUTHENTICATE SIGNAL step 402, the actions performed in the ACTION step 403 are as follows. The data transmitter transmits data from the control unit to the remote device. The data log stored in the control unit is uploaded to the remote device and the control unit retains the last sealing ID and associated data. In this way, the control unit is not fully cleared of data. Data regarding the authorization signal authorizing data transfer is stored in the control unit, including the data and time of receipt of the signal.

The user may then create a log of data comprising tracking history of the flight cart; a maintenance schedule; a list of approved and unapproved users; a list of supervising or managerial users; auditing and management reports for investigation purposes; manifest creation; management reporting portal for asset management and/or a database of authentication devices. For example, approved authentication devices may be added or removed from the database of authentication devices. Additionally, at least a portion of the log of data can be uploaded to a second flight cart. The electronic security device can also be reprogrammed within twenty-four hours. Further, the electronic security device aids in ensuring staff, such as warehouse and cabin crew, follow defined operation processes. Additionally, there can be improved operational efficiency and accuracy in the administration and preparation of custom manifests. For example, electronic creation of outbound manifests will only be successful if all flight carts selected for a flight are properly recorded as sealed. As a quasi-pseudo-random sealing ID can be provided, the electronic seal provided by the device is clone-proof. Further, the issuance of each sealing ID is configured such that the seal number is guaranteed not to repeat itself in successive issuances.

Other embodiments of the invention not described herein are envisaged. For example, it is understood that the overall dimensions of the electric security device may vary depending on the application of the device. Additionally, the display configuration and size may vary depending on the length of the sealing IDs and the notification messages desired.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A flight cart electronic security device for monitoring access to a flight cart, said electronic security device comprising;
a first portion,
a second portion, and
a retaining mechanism,
said retaining mechanism configured to retain said first portion relative to said second portion,
wherein said electronic security device further comprises a control unit,
wherein said control unit is configured to receive information from a sensor concerning the status of the first portion relative to the retaining mechanism, and further wherein said control unit is configured to control the status of said electronic security device in response to the information from the sensor and to an authorization signal.

2. The electronic security device of claim 1, wherein said control unit is further configured to store data concerning the status of said electronic security device comprising at least one of a sealing status or a tamper status.

3. The electronic security device of claim 1 or claim 2, wherein said control unit is further configured to store data concerning said authorization signal.

4. The electronic security device of claim 3, wherein said data concerning said authorization signal comprises at least one of a current sealing identification (ID), a previous sealing ID or a future sealing ID.

5. The electronic security device of any one preceding claim, wherein said electronic security device further comprises a data transmitter configured to transmit data from said control unit.

6. The electronic security device of claim 5, wherein said electronic security device is configured to transmit data to an external storage unit.

7. The electronic security device of any one preceding claim, wherein said electronic security device comprises a digital display.

8. The electronic security device of any one preceding claim, wherein said electronic security device further comprises an audible alarm.

9. The electronic security device of any one preceding claim, wherein said electronic security device further comprises a visual alarm.

10. The electronic security device of any one preceding claim, wherein said control unit is configured to receive radio frequency identification technology (RFID) authorization from an authorization device.

11. The electronic security device of any one preceding claim, wherein said electronic security device comprises a power source.

12. A kit of parts comprising;
the flight cart electronic security device of any one of claims 1 to 11; and
an authorization device configured to emit an authorization signal.

13. The kit of parts of claim 12, wherein the authorization device is a radio frequency identification technology (RFID) device.

14. Use of the flight cart electronic security device of any one of claims 1 to 11 to monitor access to a flight cart.
